(19) United States
(12) Patent Application Publication
(10) Pub. No.: US 2011/0314558 A1
(43) Pub. Date: Dec. 22, 2011

(54) METHOD AND APPARATUS FOR CONTEXT-AWARE AUTHENTICATION

(75) Inventors: Zhexuan Song, Sunnyvale, CA (US); Jesus Molina, San Francisco, CA (US)

(73) Assignee: FUJITSU LIMITED, Kanagawa (JP)

(21) Appl. No.: 12/816,966

(22) Filed: Jun. 16, 2010

(51) Int. Cl. G06F 21/00

(52) U.S. Cl. 726/28

(57) ABSTRACT

A method for authenticating access to an electronic document. The method includes receiving an authentication request from a user, receiving an aggregate risk score, selecting an authentication mechanism based at least on the aggregate risk score, and applying the authentication mechanism to decide the authentication request from the user. The aggregate risk score may be based at least on a comparison of the user's past behavior with a plurality of context data associated with the user.

### TECHNICAL FIELD

This disclosure relates in general to communication systems and more particularly to a method and apparatus for context-aware authentication within a communication system.

### BACKGROUND

When sharing electronic documents in a networked environment, whether the unsecured Internet or a private intranet, it may be desirable to maintain secure access to an electronic document after a user passes an initial authentication point. Such security may be particularly desirable when the electronic document contains private or sensitive information. Several methods exist to verify the identity of a user attempting to gain access to a share electronic document, such as username and password combinations, and public/private key combinations.

After an initial authentication via any one of these methods, however, it may often be desirable to ensure that the authenticated user remains the only user authorized to view the electronic document. For instance, in public computing environments, an authorized user may walk away from an authenticated computing session. Additionally, an unauthorized user may attempt to access an electronic document using the authenticated user's first access.

As more and more electronic documents are stored remotely and access to that data through various services becomes increasingly important, it will become correspondingly important to protect the content of those documents and allow access only to those that the author desires to grant access.

### SUMMARY OF THE DISCLOSURE

The present disclosure provides a method and apparatus for authenticating access to an electronic document that substantially eliminates or reduces at least some of the disadvantages and problems associated with previous methods and systems.

According to one embodiment, a method for authenticating access to an electronic document may include receiving an authentication request from a user, receiving an aggregate risk score selecting an authentication mechanism based at least on the aggregate risk score, and applying the authentication mechanism to decide the authentication request from the user. The aggregate risk score may based at least on a comparison of the user's past behavior with a plurality of context data associated with the user.

Also provided is an authentication system for authenticating access to an electronic document. The authentication system may include an authentication module configured to receive an authentication request from a user, receive an aggregate risk score, select an authentication mechanism based at least on the aggregate risk score, and apply the authentication mechanism to decide the authentication request from the user. The aggregate risk score may be based at least on a comparison of the user's past behavior with a plurality of context data associated with the user.

Also provided is an authentication system for authenticating access to an electronic document. The authentication system may include a context analysis engine configured to receive a request for an aggregate risk score, collect a plurality of context data associated with a user requesting access to the electronic document, compare the plurality of context data associated with the user to the user's past behavior to generate the aggregate risk score, and communicate the aggregate risk score to an authentication module. The aggregate risk score may be configured to enable the authentication module to select an authentication mechanism to apply to a request by the user to access the electronic document.

Technical advantages of certain embodiments of the present disclosure include providing secure means of authenticating a user's access to an electronic document. More particularly, this approach allows the an electronic document to be protected from view by unauthorized users who may be using an initial authentication of an authorized user to gain access to the electronic document. Further, there is increased flexibility and control in providing and/or requiring multiple levels of authentication, with each authentication level potentially using a different authentication mechanism. Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a simplified block diagram of an authentication system, in accordance with certain embodiments of the present disclosure;

FIG. 2 illustrates a flow chart of an example method for authenticating access to an electronic document, in accordance with certain embodiments of the present disclosure;

FIG. 3 illustrates a flow chart of an example method for authenticating access to an electronic document, in accordance with certain embodiments of the present disclosure; and

FIG. 4 illustrates a flow chart of an example method for analyzing a context report in order to authenticate access to an electronic document, in accordance with certain embodiments of the present disclosure.

### DETAILED DESCRIPTION OF THE INVENTION

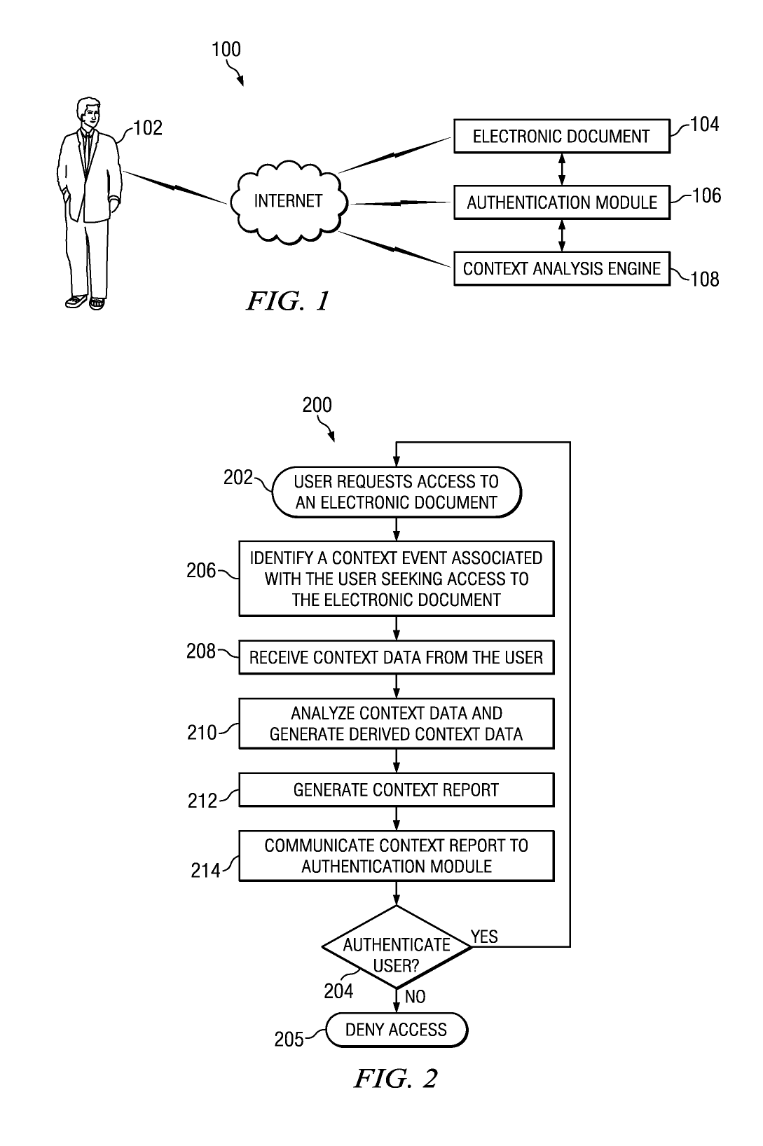

FIG. 1 is a simplified block diagram of an authentication system 100, in accordance with certain embodiments of the present disclosure. According to the illustrated embodiment, authentication system 100 includes at least one user 102 requesting access to electronic document 104, and in communication with authentication module 106 and context analysis engine 108.

For purposes of this disclosure, an “electronic document” or “document” may be any file, files, web page, remote application, computer service or services, network access application, intranet or internet access application, object code, executable code, data records, or any other electronically recorded data structure that user 102 of authentication system 100 may wish to access. Illustrative examples may include text files, spreadsheets, email, medical records, images, and other electronic data, as well as web pages, private networks, word processing programs, file management systems, and other programs. Additionally, user 102 of authentication system 100 may refer to a person acting as an end user or to the device or devices used by such a person to access authentication system 100, such as a personal computer, kiosk, or mobile computing device. Further, for ease of illustration, only one user 102 is shown. However, multiple users 102 may be present within authentication system 100. Additionally, user(s) 102 may request access to one or more electronic document(s) 104.

In general, the components of authentication system 100 may act to periodically authenticate user 102 through repeated requests for access to electronic document 104 through the collection of context data specific to user 102 by context analysis engine 108, and the further analysis of that context data by authentication module 106, as described in more detail below with reference to FIGS. 2-4. User 102 may initially request access to electronic document 104. Authentication module 106 may then determine whether user 102 should be permitted to access electronic document 104. Authentication module 106 may use any of a variety of authentication mechanisms, including username/password, public/private key, biometrics, or other appropriate authentication mechanisms. User 102 may, at a later time, again request access to electronic document 104. In some embodiments, this may occur after the passage of a predetermined period of time. In other embodiments, active analysis of context data may act to require reauthentication independent of time.

Authentication module 106 may determine whether to continue the access of user 102 without further authentication, reauthenticate user 102 using the same authentication mechanism used during the initial authentication, require user 102 to authenticate using a different authentication mechanism, or immediately terminate the access of user 102 with no further authentication allowed.

In some embodiments, authentication module 106 may make this determination based at least on context data specific to user 102 as gathered by context analysis engine 108. The context data gathered by context analysis engine 108 may include data representative of user 106 such as physical or network location (e.g., GPS location, IP address), certain software installed on the requesting machine (e.g., rigorous antivirus software), biometric identifiers, time spent by user 102 with electronic document 104, location of a designated end-user relative to user 102 (e.g., through use of a camera), or any other appropriate context attributes of user 102.

For clarity of description, FIG. 1 depicts authentication module 106 and context analysis engine 108 as separate modules. In some embodiments, they may be stand-alone software programs stored on computer-readable media and executable by the processor of the same or different computers. However, authentication module 106 and context analysis engine may also be components or subroutines of a larger software program, or hard-coded into computer-readable media, and/or any hardware of software modules configured to perform the desired functions.

FIG. 2 illustrates a flow chart of an example method 200 for authenticating access to an electronic document, in accordance with certain embodiments of the present disclosure. Method 200 includes identifying a context event, receiving context data, analyzing the context data, generating a context report, and communicating the context report to authentication module 106.

According to one embodiment, method 200 preferably begins at step 202. Teachings of the present disclosure may be implemented in a variety of configurations of authentication system 100. As such, the preferred initialization point for method 200 and the order of steps 202-214 comprising method 200 may depend on the implementation chosen. Additionally, the steps of method 200 may be performed in any appropriate order other than the order illustrated.

At step 202, user 102 request access to electronic document 104 from authentication module 106. Electronic document 104 may, in some embodiments, be any file, files, web page, remote application, computer service or services, network access application, intranet or internet access application, object code, executable code, data records, or any other electronically recorded data structure that user 102 of authentication system 100 may wish to access. After requesting authentication, method 200 may then proceed to step 206.

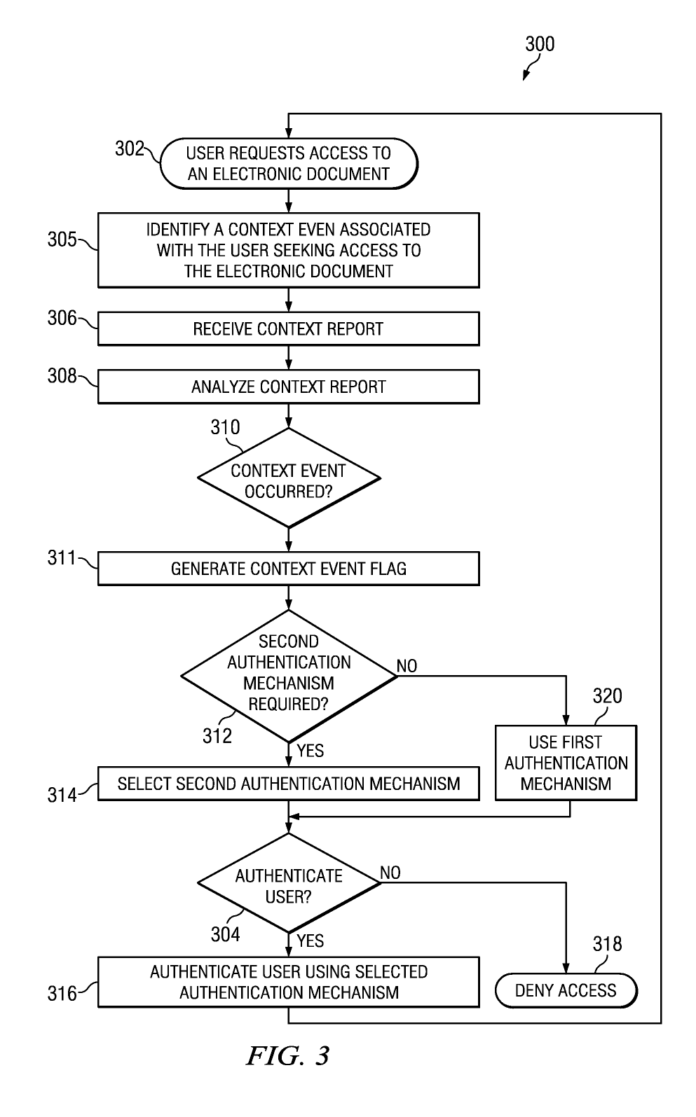

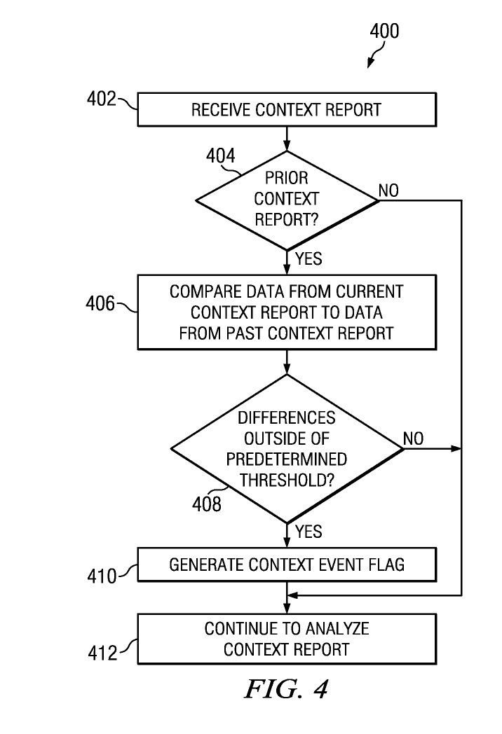

At step 206, authentication module 106 may identify a context event associated with user 102. This context event may be any event associated with the computing context of user 102. In some embodiments, the context event may include: suspicious activity in the use of electronic document 104 by user 102, physical or network location of user 102 (e.g., as measured by IP address or GPS location), physical presence of user 102 in front of an access device (e.g., by monitoring a video feed from the access device), an aggregate estimation of the generalized risk level presented by user 102, or any other appropriate event configured to mark a change in the context of user 102 as related to the risk level of user 102. In some embodiments, identification of the context event may include selecting from among a set of potential context events in order to determine the subset of context data most relevant to authentication. The context event is described in more detail below with reference to FIGS. 3-4. After identifying the context event, method 200 may proceed to step 208.

At step 208, context analysis engine 108 may receive context data from user 102. Such context data may include the IP address of user 102, GPS location of user 102, type of access device used with user 102 (e.g., desktop computer, laptop computer, kiosk, cellular phone, etc.), other software and/or hardware present with user 102, a video feed from the access device used by user 102 indicating whether user 102 is present with the access device, data indicating biometric information from user 102 (e.g., fingerprint data), time user 102 has been actively accessing electronic document 104, the actual data stream sent to access electronic document (e.g., to monitor the patterns for suspicious activities), or other context data associated with user 102. Context analysis engine 108 may, in some embodiments, gather the context data from user 102 by requesting such data from user 102. In other embodiments, user 102 may push context data to context analysis engine 108 rather than waiting for a context data request. In such an embodiment, an important piece of context data, and an associated context event, may be the time period over which context analysis engine 108 should expect to receive context data from user 102 and whether such context data was in fact received within that time period. The push of context data from user 102 may be accomplished by a software and/or hardware module associated with the access device of user 102. In addition to pushing context data at a predetermined frequency, user 102 may also push context data upon an occurrence of a particular event, such as the addition of hardware to the access device.

In some embodiments, context analysis engine may be part of the same computing device or devices as authentication module 106. In other embodiments, context analysis engine 108 may be physically and/or logically separate from authentication module 106. After receiving the context data from user 102, method 200 may proceed to step 210.

At step 210, context analysis engine 108 may analyze the received context data, including in order to derive one or more pieces of derived context data. In some embodiments, context analysis engine 108 may compile all, or some subset of, relevant context data concerning user 102 into an aggregate number representative of the overall risk level of user 102. As an illustrative example only, context analysis engine 108 may compile context data including a user's IP address, username/password, and usage patterns to form a model of behavior for user 102. Such a model may represent the typical access pattern for user 102, a deviation from which may indicate that a nonauthenticated user is attempting to access electronic document 104. In some embodiments, generating derived context data may have the advantage of simplifying the authentication decision of authentication module 106, as described in more detail below with reference to FIGS. 3-4.

Once context analysis engine 108 has analyzed the context data, method 200 may proceed to step 212, wherein context analysis engine 108 may generate a context report. The context report may, in some embodiments, include one or more indicators of the risk level of user 102. For instance, the context report may include only the aggregate number representative of the overall risk level of user 102. In other embodiments, the context report may include a subset of context data which context analysis engine 108 may have determined were particularly appropriate to determining the risk associated with user 102. After generating the context report, method 200 may proceed to step 214, wherein the context report is communicated to authentication module 214.

After communicating the context report to authentication module 214, method 200 may proceed to step 204, where authentication module 106 may determine whether to authenticate user 102 based on a chosen authentication mechanism, such as username/password or biometrics. If user 102 is not to be authenticated, method 200 may proceed to step 205, where access is denied to user 102. After denying access, method 200 may end. If user 102 is to be authenticated, method 200 may return to step 202. In some embodiments, user 102 may request access to electronic document 104 multiple times in a single session. As an illustrative example, user 102 may request to write to a portion of electronic document 104, read a different portion of electronic document 104, access a different area of electronic document 104, or request additional resources within electronic document 104.

Although FIG. 2 discloses a particular number of steps to be taken with respect to method 200, method 200 may be executed with more or fewer steps than those depicted in FIG. 2. For instance, in some embodiments, context analysis engine 108 may not wait for user 102 to request access to electronic document 104 before examining the context of user 102 and authentication module 106 making an authentication decision for user 102. In some embodiments, context analysis engine 108 may continuously monitor user 102 for changes in context data and authentication module 106 may preemptively terminate access of user 102.

In other embodiments, method 200 may include the further steps of comparing received context data with previously received context data in order to determine whether the context of user 102 has changed over time. In some embodiments, particularly embodiments in which context analysis engine 108 and authentication module 106 are subcomponents of a larger software and/or hardware method, the generating and communicating of the context report may be a single step.

In addition, although FIG. 2 discloses a certain order of steps comprising method 200, the steps comprising method 200 may be completed in any suitable order. For example, in the embodiment of method 200 shown, context analysis engine 108 received context data from user 102 after user 102 is authenticated to access electronic document 104. In some configurations, context analysis engine 108 may operate to continually receive context data from user 102 regardless of whether user 102 has requested access to a particular electronic document 104. For instance, in a private network, context analysis engine 108 may begin receiving context data from user 102 upon access to the private network by user 102 but before user 102 requests access to another electronic document 104 (recognizing that the private network itself may qualify as another electronic document 104).

FIG. 3 illustrates a flow chart of an example method 300 for authenticating access to an electronic document, in accordance with certain embodiments of the present disclosure. Method 300 includes identifying a context event, receiving a context report, determining whether a context event has occurred, generating a context event flag, determining whether a second authentication mechanism is required, and reauthenticating a user.

According to one embodiment, method 300 preferably begins at step 302. Teachings of the present disclosure may be implemented in a variety of configurations of authentication system 100. As such, the preferred initialization point for method 300 and the order of steps 302-320 comprising method 300 may depend on the implementation chosen. Additionally, the steps of method 300 may be performed in any appropriate order other than the order illustrated.

In some embodiments, steps 302, 305, 306, and 308 may correspond to steps 202, 206, 208, and 210 of method 200, respectively, as described in more detail above with reference to FIG. 2. At step 302, user 102 request access to electronic document 104 from authentication module 106. After requesting access, method 300 may proceed to step 305, where authentication module 106 may identify a context event associated with user 102. After identifying the context event, method 300 may proceed to step 306.

At step 306, authentication module 106 may receive a context report from context analysis engine 108. The context report is described in more detail above with reference to FIGS. 1-2. After receiving the context report, method 300 may proceed to step 308, where authentication module 106 may analyze the context report. In some embodiments, analyzing the context report may include comparing context data to a predetermined threshold to determine whether the context data associated with user 102 is outside of that predetermined threshold. As an illustrative example only, the context report may include an aggregate number representative of the overall risk level of user 102. In some embodiments, this aggregate number may range from zero (worst security risk) to 100 (best security risk). A predetermined risk threshold may be set at, for instance, 75. If the aggregate risk level for user 102 is below 75, then authentication module 106 may require reauthentication of user 102.

In other embodiments, analyzing the context report may include comparing changes in context data to a predetermined threshold, as described in more detail below with reference to FIG. 4. Using the illustrative example above, an aggregate number may be an aggregate risk score generated by comparing a previously identified model of a risk profile of user 102 with the gathered context data corresponding to user 102. This comparison may be used to calculate a probability that user 102 requesting access to electronic document 104 is the authenticated user.

In some embodiments, the aggregation of context data may be the responsibility of authentication module 106. In such an embodiment, analyzing the context report may include analyzing the context data and/or derived context data received from context analysis engine 108 in order to determine an aggregate number representative of the overall risk level of user 102. Other analytical functions, such as analyzing data for reporting, may be part of step 308. After analyzing the context report, method 300 may proceed to step 310.

At step 310, authentication module 106 may determine whether a context event has occurred. In the illustrative example above, the threshold event may be an aggregate risk level below 75. In other embodiments, step 310 may include determining whether: user 102 has moved outside of a predetermined secure zone, suspicious activities from user 102 have been received, or other context events as described in more detail above with reference to FIGS. 1-2. If no context event has occurred, then method 300 may return to step 306 to receive another context report. If a context event has occurred then method 300 may proceed to step 312.

At step 312, authentication module 106 may determine whether a second authentication mechanism is required. In some embodiments, a context event may require a second authentication mechanism. This may occur in situations in which the context event has been determined to indicate what may potentially be a more egregious security breach. As an illustrative example only, if the context event is suspicious activity (e.g., as indicated in certain patterns received from user 102), then authentication module 106 may require user 102 to reauthenticate with a more secure authentication mechanism such as biometrics.

In some embodiments, a context event may be triggered without requiring an authentication mechanism different from the authentication mechanism used to previously authenticate user 102. As an illustrative example only, if user 102 initially accesses electronic document 104 via a username and password, the context event is attempted access to a different part of electronic document 104 within a predetermined range (e.g., user 102 has logged into a remote document repository and requests access to a different document) and no significant changes to other context data has occurred, authentication module 106 may require user 102 to reauthenticate with just the username and password again. When no second authentication mechanism is required, method 300 may proceed to step 320, where authentication module 106 may continue to use the first authentication mechanism. Once selected, method 300 may proceed to step 304, where the authentication decision is made.

If a second authentication mechanism is required, method 300 may proceed to step 314, where the second authentication mechanism is selected. In some embodiments, the second authentication mechanism may be chosen from among a set of possible authentication mechanisms based on the severity of the change in context data. After selecting the appropriate second authentication mechanism, method 300 may proceed to step 304, where the authentication decision is made.

At step 304, authentication module 106 may determine whether to authenticate user 102 based on the currently in use authentication mechanism. If user 102 is not to be authenticated, method 300 may proceed to step 318, where access is denied to user 102. After denying access, method 300 may end. If user 102 is to be authenticated, method 300 may return to step 302. In some embodiments, user 102 may request access to electronic document 104 multiple times in a single session. As an illustrative example, user 102 may request to write to a portion of electronic document 104, read a different portion of electronic document 104, access a different area of electronic document 104, or request additional resources within electronic document 104.

Although FIG. 3 discloses a particular number of steps to be taken with respect to method 200, method 200 may be executed with more or fewer steps than those depicted in FIG. 3. For instance, in some embodiments, context analysis engine 108 may not wait for user 102 to request access to electronic document 104 before examining the context of user 102 and authentication module 106 making an authentication decision for user 102. In some embodiments, context analysis engine 108 may continuously monitor user 102 for changes in context data and authentication module 106 may preemptively terminate access of user 102.

In other embodiments, multiple types of context data may be analyzed, and each examined to determine whether a context event has occurred. Further, in some embodiments, the context report may indicate that more than one context event has occurred. In such embodiments, it may be desirable to prioritize the context events before proceeding through the remainder of method 300. For instance, if a context report indicates both that context data has not been received from user 102 in the proscribed time period and that user 102 has moved to a nonsecure zone, it may be desirable to prioritize the latter context event over the former such that a second authentication mechanism may be required. In other embodiments, a context event may be defined to be a combination of other context events. In still other embodiments, a context event may indicate such a potentially egregious security breach that access by user 102 to electronic document 104 may be immediately terminated without further authentication.

FIG. 4 illustrates a flow chart of an example method 400 for analyzing a context report in order to authenticate access to electronic document 104, in accordance with certain embodiments of the present disclosure. Method 400 includes receiving a context report, determining whether a prior context report exists, comparing data of the current and prior context reports, and determining whether any differences justifies an occurrence of a context event.

According to one embodiment, method 400 preferably begins at step 402. Teachings of the present disclosure may be implemented in a variety of configurations of authentication system 100. As such, the preferred initialization point for method 400 and the order of steps 402-412 comprising method 400 may depend on the implementation chosen. Additionally, the steps of method 400 may be performed in any appropriate order other than the order illustrated. In some embodiments, steps 402-412 of method 400 may occur within a process described by steps 306-308 of method 300, as described in more detail below with reference to FIG. 3.

At step 402, authentication module 106 may receive a context report from context analysis engine 108. The context report is described in more detail above with reference to FIGS. 1-3. After receiving the context report, method 400 may proceed to step 404, where authentication module 106 may determine whether it has received a prior context report. In some embodiments, this determination may be made in accordance with a predetermined time period. For example, the search for a prior context report may be limited to the previous five minutes. If no prior context report exists, method 400 may proceed to step 412, where the current context report is analyzed, as described in more detail above with reference to FIGS. 1-3. If a prior context report exists, method 400 may proceed to step 406.

At step 406, authentication module 106 may compare data from the current context report to data from the prior context report or reports. In some embodiments, the context report may include an aggregate number representative of the overall risk level of user 102. As an illustrative example only, this aggregate number may range from zero (worst security risk) to 100 (best security risk). Using the illustrative example above, an aggregate number may be an aggregate risk score generated by comparing a previously identified model of a risk profile of user 102 with the gathered context data corresponding to user 102. This comparison may be used to calculate a probability that user 102 requesting access to electronic document 104 is the authenticated user.

In some embodiments, the aggregate risk score may be generate from a combination of analyses of multiple context values. As an illustrative example, context analysis engine 108 may analyze the physical location of user 102. The physical location may be compared with previous physical locations of user 102. If the combination of physical location values are grouped well, then the aggregate risk score may be low (e.g., low risk). Alternatively, if the current physical location of user 102 is far from previous physical locations, the aggregate risk score may be high (e.g., high risk). As another illustrative example, context data associated with user 102 may include telephone calls placed by user 102. A call placed by user 102 may be compared with the previous phone call history of user 102. If the current call is known and/or frequently appears in the history of user 102, the aggregate risk score may be low (e.g., low risk). If the current call is unknown, the aggregate risk score may be high (e.g., high risk).

In some embodiments, the aggregate risk score, when based on a combination of analyses of multiple context values, may be based on a reverse normalization of the combination of multiple context values. For example, if one context value indicates a high risk, that context value may outweigh a plurality of other context values that indicate a low risk such that the aggregate risk score may indicate a high level of risk.

At step 406, the aggregate number for the current context report may be compared to the aggregate number for the prior context report. In the illustrative example, the prior aggregate number may be 100 and the current aggregate number may be 76. After comparing the current and prior data, method 400 may proceed to step 408.

At step 408, authentication module 106 may determine whether the differences between the current and prior context data are outside of a predetermined threshold. In some embodiments, it may be desirable to base authentication decisions at least partly on changes in raw or derived context data rather than the raw or derived context data itself. In the illustrative example, if the aggregate number threshold required for reauthentication is 75, then authentication system 100 may be configured in such a way that reauthentication is not required by an aggregate number of 76. However, in the illustrative example described above, authentication system 100 may be configured in such a way that a difference in aggregate number of 24 (e.g. 100 less 76) may be sufficient to establish an occurrence of a context event. If authentication module 106 determines that the differences in context data are not outside of a predetermined threshold, then method 400 may proceed to step 412, where the current context report is analyzed, as described in more detail above with reference to FIGS. 1-3. If the differences in context data are outside of a predetermined threshold, then method 400 may proceed to step 410, where a context event flag is generated. After generating the context event flag, method 400 may proceed to step 412, where the current context report continues to be analyzed, as described in more detail above with reference to FIGS. 1-3.

Although FIG. 4 discloses a particular number of steps to be taken with respect to method 400, method 400 may be executed with more or fewer steps than those depicted in FIG. 4. For instance, in some embodiments, the context report may indicate more than one set of context data. In such embodiments, it may be desirable to prioritize the sets of context data before proceeding through the remainder of method 400. For instance, if a context report indicates both that user 102 has a marked increase in data queries and that the aggregate risk number of user 102 has changed substantially, it may be desirable to prioritize the latter context event over the former such that a second authentication mechanism may be required or to indicate that access should be immediately revoked. In other embodiments, a context event may be defined to be a combination of other context events.

Using the methods and systems disclosed herein, certain problems associated with maintaining secure access to electronic document 104 may be improved, reduced, or eliminated. For example, the methods and system disclosed herein allow for the continuous monitoring of context data associated with user 102 in order to ensure that the authenticated user is the only one allowed to continue to access electronic document 104.

What is claimed is:

1. A method for authenticating access to an electronic document, comprising:
receiving an authentication request from a user;
receiving an aggregate risk score, the aggregate risk score based at least on a comparison of the user's past behavior with a plurality of context data associated with the user;
based at least on the aggregate risk score, selecting an authentication mechanism; and
applying the authentication mechanism to decide the authentication request from the user.

2. The method of claim 1, wherein the authentication mechanism is a biometric authentication mechanism.

3. The method of claim 1, wherein the authentication mechanism is a smart card.

4. The method of claim 1, wherein selecting the authentication mechanism comprises not requiring an active authentication mechanism, and applying the authentication mechanism to decide the authentication request from the user comprises granting the user access with no authentication.

5. The method of claim 1, wherein selecting the authentication mechanism comprises not requiring an active authentication mechanism, and applying the authentication mechanism to decide the authentication request from the user comprises denying the user access with no authentication.

6. An authentication system for authenticating access to an electronic document, comprising an authentication module configured to:
receive an authentication request from a user;
receive an aggregate risk score, the aggregate risk score based at least on a comparison of the user's past behavior with a plurality of context data associated with the user;
based at least on the aggregate risk score, select an authentication mechanism; and
apply the authentication mechanism to decide the authentication request from the user.

7. The authentication system of claim 6, wherein the authentication mechanism is a biometric authentication mechanism.

8. The authentication system of claim 6, wherein the authentication mechanism is a smart card.

9. The authentication system of claim 6, wherein the authentication module is further configured to select the authentication mechanism by not requiring an active authentication mechanism, and to apply the authentication mechanism to decide the authentication request from the user by granting the user access with no authentication.

10. The authentication system of claim 6, wherein the authentication module is further configured to select the authentication mechanism by not requiring an active authentication mechanism, and to apply the authentication mechanism to decide the authentication request from the user by denying the user access with no authentication.

11. An authentication system for authenticating access to an electronic document, comprising a context analysis engine configured to:
receive a request for an aggregate risk score;
collect a plurality of context data associated with a user requesting access to the electronic document;
compare the plurality of context data associated with the user to the user's past behavior to generate the aggregate risk score; and
communicate the aggregate risk score to an authentication module, wherein the aggregate risk score is configured to enable the authentication module to select an authentication mechanism to apply to a request by the user to access the electronic document.

12. The authentication system of claim 11, wherein the authentication mechanism is a biometric authentication mechanism.

13. The authentication system of claim 11, wherein the authentication mechanism is a smart card.

14. The authentication system of claim 11, wherein the aggregate risk score is further configured to enable the authentication module to grant the user access with no authentication.

15. The authentication system of claim 11, wherein the aggregate risk score is further configured to enable the authentication module to deny the user access with no authentication.
